(19) United States
(12) Patent Application Publication
(10) Pub. No.: US 2012/0242816 A1
(43) Pub. Date: Sep. 27, 2012

(54) RECOGNITION SYSTEM FOR FIREARMS

(76) Inventor: Arnaldo Zael Cruz, Miami, FL (US)

(21) Appl. No.: 13/430,611

(22) Filed: Mar. 26, 2012

Related U.S. Application Data
(60) Provisional application No. 61/467,290, filed on Mar. 24, 2011.

(51) Int. Cl. G08B 13/00; H04N 7/18

(52) U.S. Cl. 348/77; 340/568.1; 348/143; 348/E07.085

(57) ABSTRACT

A recognition system recognizes and prevents the unlawful use of a firearm. The present invention also provides a means for tracking and tracing the history of a firearm movement and registered ownership. The recognition system may include a variety of scanning devices that may be adapted to scan for a firearm and/or may scan for a special component formed into the firearm material. The scanning devices may be made visible to people to act as a deterrent, or may be hidden in various everyday items, such as in exit signs, advertisement displays and the like. The scanning devices may not only detect firearms, but other items that may be restricted in their carry, such as knives, narcotics, explosives, or the like.

### CROSS-REFERENCE TO RELATED APPLICATION

This application claims the benefit of priority of U.S. provisional patent application No. 61/467,290, filed Mar. 24, 2011, the contents of which are herein incorporated by reference.

### BACKGROUND OF THE INVENTION

The present invention generally relates to safety and security systems and, more particularly, to a recognition system for firearms or other security sensitive items.

Tracking and detecting firearms is an important safety and security concern. In many states, the carrying of firearms is restricted in certain facilities, such as schools, bars, airports and the like. However, there are rarely any means for detecting whether someone is bringing a firearm into a restricted area.

Moreover, if a firearm is used, for example, in committing a felony, there is currently no way to trace the history of the firearm. If a firearm is lost or stolen from a lawful owner, there is no way to determine where that firearm has gone.

As can be seen, there is a need for a recognition system and method for tracking or sensing firearms or other security sensitive items.

### SUMMARY OF THE INVENTION

In one aspect of the present invention, a firearm recognition system comprises a recognition sensor disposed in a firearm; and a sensor adapted to detect the recognition sensor.

In another aspect of the present invention, a method for detecting a firearm comprises configuring the firearm with a recognition sensor; scanning a selected area with a sensor adapted to detect the recognition sensor.

These and other features, aspects and advantages of the present invention will become better understood with reference to the following drawings, description and claims.

### BRIEF DESCRIPTION OF THE DRAWINGS

FIG. 1 is a perspective view of a corridor having an advertisement display with a firearm sensor according to an exemplary embodiment of the present invention;

FIG. 2 is a detail view of the advertisement display of FIG. 1;

FIG. 3 is a front view of an exit sign having an opening for a sensor to send and receive signals to detect a firearm; and

FIG. 4 is a perspective view of a firearm having a detectable feature according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a recognition system for recognizing and preventing the unlawful use of a firearm. The present invention also provides a means for tracking and tracing the history of a firearm movement and registered ownership. The recognition system may include a variety of scanning devices that may be adapted to scan for a firearm and/or may scan for a special component formed into the firearm material. The scanning devices may be made visible to people to act as a deterrent, or may be hidden in various everyday items, such as in exit signs, advertisement displays and the like. The scanning devices may not only detect firearms, but other items that may be restricted in their carry, such as knives, narcotics, explosives, or the like.

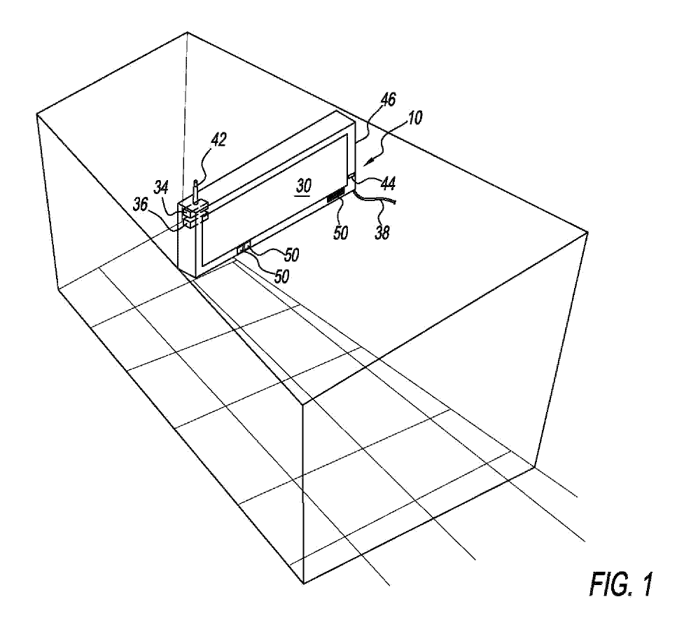

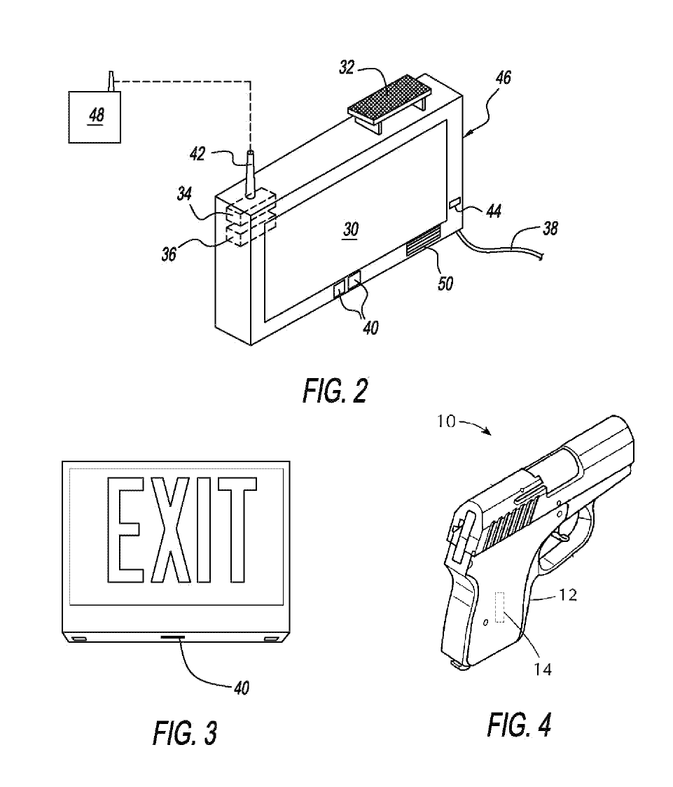

Referring to FIGS. 1 through 4, embodiments of the present invention may include a recognition sensor 14 inside of a firearm 10. The recognition sensor 14 may be a micro transmitter or a readable tag disposed inside the firearm 10. The recognition sensor 14 may be disposed within the firearm 10 so that it cannot be removed therefrom. For example, the recognition sensor 14 may be formed inside the firearm 10 during its manufacture. In some embodiments, the recognition sensor 14 may be formed in a handle 12 of the firearm 10.

Sensors 40, 44, 46, 50 may be disposed at various locations to detect the recognition sensor 14 of the firearm 10. In some embodiments, the sensors may not only detect the recognition sensor 14, but may also gain information about the firearm 10, such as a registration number. The sensors may transmit this information into a database 48 for tracking the movements of the firearm 10. In some embodiments, for example, at an entrance to a facility where firearms are not permitted (such as that shown in FIG. 1, for example), the sensor may detect the firearm 10 and, for example, may sound an alarm, prevent access, or notify the authorities. In some embodiments, the sensors may be programmed to distinguish between permitted firearms and unauthorized firearms. For example, in an airport, the sensors may be designed to detect the recognition sensor of firearms and certain registration numbers (such as those from authorized TSA agents, US Marshalls, or the like) may be permitted and may not sound an alarm when the firearm is detected.

The sensors may be housed in a housing 46. The housing may have a display screen 30, may be an exit sign as shown in FIG. 3, or may be some other structure in the area where sensing is desired. The housing may have a wireless module 34 with an antenna 42 for sending a signal to a receiving station 48, which may include a database for storing data. A power cord 38 may provide power to the device and/or solar panels 32 may provide solar power to the device, where appropriate.

The device may include a memory module 36. The memory module 36 may store information that may be useful to have on hand in the device. For example, the memory module 36 may contain information on permitted firearm registration numbers so that the device can immediately sense a permitted firearm and not sound an alert.

In some embodiments, when the sensor detects a prohibited item, such as a firearm, one of the sensors may be replaced with a camera such as sensor 50 may be a camera 50. The camera 50 may take a picture of the person that caused an alert, send the picture to the receiving station 48, where facial recognition software may be used to help determine a threat. In some embodiments, when the sensor detects a prohibited item, a signal may be used to activate a GPS feature in an electronic device that may be carried by the person carrying the prohibited item. This GPS signal may be sent to the proper authorities to track the movement of the person carrying the prohibited item. Sensors posted at multiple locations may help track the movements of the person.

The sensors may be disposed at various locations. In some embodiments, the sensors may be disposed in exit sign sensors, thereby providing detection at already labeled locations, as shown in FIG. 3. The sensors may be disposed in doorways, security gates, shopping malls, parking garages, bridges, tunnels, airports and other mass transit terminals, and the like. The sensors may be used to detect a specially designed paint, ink or pigment used in the manufacturer of the firearm. For example, the sensor may include a safe ultraviolet light that may cause the firearm to emit a detectable light. In some embodiments, the detectable light may not be noticeable to the human eye, thereby not alerting the carrier of the firearm that a sensor is in use. For example, the sensor could be a laser, such as a quantum cascade laser. In some embodiments, the sensors may include an infrared light for detecting metal objects, for example. In some embodiments, the sensor could be an infrared camera. In other embodiments, the sensor may use other known technology, such as reverse photoacoustic standoff spectroscopy, as described in U.S. patent publication 2010/033720, the contents of which are herein incorporated by reference.

In some embodiments, the sensors may be deployed in private residences and may be tied in with the resident's alarm system. The sensor may detect the presence of a firearm and may be programmed to send an alert, either as a stand-alone system, or part of an integrated alarm system, to the resident. The alert may be sent by, for example, phone message, text message, email, or the like. Such a system may allow a homeowner to know when someone enters their home while carrying a firearm. The system may be programmed to work when the home security system is armed or unarmed.

The database used to record firearm movement may be programmed to watch for certain firearms, such as those that are reported lost or stolen, or those used to commit a crime. The database may be able to correlate a firearm being carried with its registered owner's eligibility to carry the firearm. The database may also record and keep track of the history of ownership of the firearm. Should the firearm be used, for example, in the commission of a felony, a single database may be used to track any detected movement of the firearm as well as its registered ownership.

While the above description discusses exemplary sensors that may be used in the present invention, it should be understood that various sensors, as may be known in the art, may be useful for sensing firearms and/or other prohibited items. For example, a plurality of explosive detection methods are known in the art. Such detection methods may be used with the firearm recognition system of the present invention to provide a more enhanced system to help thwart the carrying of potentially harmful items.

The present invention may help control the unlawful use of firearms, thereby protecting the safety and security of individuals. The present invention may also be used to protect the safety and security of individuals from other security sensitive items, such as narcotics.

It should be understood, of course, that the foregoing relates to exemplary embodiments of the invention and that modifications may be made without departing from the spirit and scope of the invention as set forth in the following claims.

What is claimed is:

1. A firearm recognition system comprising:
a recognition sensor disposed in a firearm; and
a sensor adapted to detect the recognition sensor.

2. The firearm recognition system of claim 1, wherein the sensor is adapted to obtain information identifying a detected firearm.

3. The firearm recognition system of claim 1, further comprising a reception system having a database to store information pertaining to movement of the firearm.

4. The firearm recognition system of claim 1, wherein the sensor is disposed in an exit sign.

5. The firearm recognition system of claim 1, wherein the sensor is disposed in a digital billboard.

6. The firearm recognition system of claim 1, further comprising an audible alert adapted to sound when a firearm is detected.

7. The firearm recognition system of claim 1, further comprising a wireless transmitter to send detection data to a reception station.

8. The firearm recognition system of claim 1, further comprising a camera to photograph a person marrying a prohibited item.

9. The firearm recognition system of claim 1, wherein the sensor includes at least one of a laser, an infrared signal, an ultraviolet signal, a photoacoustical signal, and an infrared camera.

10. A method for detecting a firearm, comprising:
configuring the firearm with a recognition sensor;
scanning a selected area with a sensor adapted to detect the recognition sensor.

11. The method of claim 10, further comprising determining if a detected firearm is authorized in the selected area.

12. The method of claim 10, further comprising determining if a prohibited item is in the selected area.

13. The method of claim 10, further comprising sending a signal to a reception station with data concerning tracking information on the firearm.

14. The method of claim 10, further comprising taking a photograph of a person carrying the firearm.

15. The method of claim 14, further comprising using face recognition software to identify the person.

16. The method of claim 10, further comprising maintaining a data base that is adapted to log reception of each firearm and track movement thereof.

17. The method of claim 10, further comprising discreetly positioning the sensor in a desired location.

18. The method of claim 17, wherein the sensor is positioned in an exit sign.

19. The method of claim 17, wherein the sensor is positioned in an electronic billboard.

20. The method of claim 10, wherein the sensor is positioned in a plurality of locations including doorways, security gates, shopping malls, parking garages, bridges, tunnels, airports and mass transit terminals.
